(19) United States
(12) Patent Application Publication
(10) Pub. No.: US 2018/0222029 A1
(43) Pub. Date: Aug. 9, 2018

(54) SETTING TOOL DRIVEN BY INTERNAL COMBUSTION

(71) Applicant: Hilti Aktiengesellschaft, Schaan (LI)

(72) Inventor: Rolf ERHARDT, Buchs SG (CH)

(21) Appl. No.: 15/750,992

(22) PCT Filed: Sep. 27, 2016
(86) PCT No.: PCT/EP2016/072901

§ 371 Date: Feb. 7, 2018

(30) Foreign Application Priority Data
Sep. 29, 2015 (EP) 15187360.1

(51) Int. Cl. B25C 1/08

(52) U.S. Cl. CPC B25C 1/08

(57) ABSTRACT

The invention relates to a setting tool driven by internal combustion, for driving in fastening elements, having at least one combustion chamber and one drive piston which has a first piston surface which faces the combustion chamber and a second piston surface which faces away from the combustion chamber and delimits an expansion chamber, and having a fluid conveying device which conveys a volumetric flow. In order to improve the effectiveness and/or the functionality of the setting tool a switchover device is arranged on an outlet side of the fluid conveying device, by way of which switchover device the volumetric flow can be conveyed by the fluid conveying device in full or in part to different points in or on the setting tool.

### TECHNICAL FIELD

The invention relates to a driving device operated by combustion pressure, for driving fastening elements, having at least one combustion chamber, having a driving piston which has a first piston surface which faces the combustion chamber, and a second piston surface which faces away from the combustion chamber and defines an expansion space, and having a fluid conveying device which conveys a volume flow. The invention also relates to a method for the operation of such a driving device operated by combustion pressure.

### PRIOR ART

European patent EP 2 106 883 A1 discloses a driving device operated by combustion pressure for driving fastening elements into a workpiece, having at least one combustion chamber for a fuel, having a driving piston which has a piston head and which is displaceably guided in a piston guide, wherein the driving piston can be driven via expanding gases from the combustion chamber, and having a device for resetting the driving piston to a starting position via a differential pressure between spaces on the two axial sides of the piston head, wherein the device for resetting the driving piston includes a pump which is designed as an electric suction pump connected to the combustion chamber to generate a suction air flow.

### DESCRIPTION OF THE INVENTION

The problem addressed by the invention is that of improving the effectiveness and/or the functionality of the process of driving fastening elements by means of a driving device operated by combustion pressure, the same having at least one combustion chamber, having a driving piston which has a first piston surface which faces the combustion chamber, and a second piston surface which faces away from the combustion chamber and defines an expansion space, and having a fluid conveying device which conveys a volume flow.

The problem is addressed in a driving device operated by combustion pressure for driving fastening elements having at least one combustion chamber, having a driving piston which has a first piston surface which faces the combustion chamber, and a second piston surface which faces away from the combustion chamber and defines an expansion space, and having a fluid conveying device which conveys a volume flow, in that a switching device, by means of which the volume flow can be conveyed entirely or partially to different locations in or on the driving device by the fluid conveying device, is arranged on an output side of the fluid conveying device. The fluid conveying device can be designed as a piston pump, the conveying direction of which can be relatively easily reversed. However, the fluid conveying device can also be designed as a pump of a pump type in which the conveying direction cannot be switched due to the design thereof. One pump of this type of pump is, for example, a centrifugal pump. Due to the combination of the fluid conveying device and the switching device, the conveying direction of the fluid conveying device can also be switched in pumps where this is not, or not readily, possible due to the design thereof. This accordingly simplifies, by way of example, the resetting of the piston during operation of the driving device—regardless of the type of pump of the fluid conveying device designed as a pump. The fluid can be gas, such as air, and in particular ambient air. In this case, the fluid conveying device designed as a pump is also referred to as a compressor.

A preferred embodiment of the driving device operated by combustion pressure is characterized in that the switching device is a valve device having at least three connections, one of which is connected to the output side of the fluid conveying device. The valve device is preferably a directional control valve. The directional control valve with the at least three connections can create at least two different paths for the volume flow conveyed by means of the fluid conveying device. This makes it possible, with one and the same fluid conveying device, to supply different locations in or on the driving device with a volume flow, and optionally also with a partial volume flow, at different time points during operation.

A further preferred embodiment of the driving device operated by combustion pressure is characterized in that the switching device has a connection for the combustion chamber. As a result, a fluidic connection between the output side of the fluid conveying device and the combustion chamber is made possible in a simple manner.

A further preferred embodiment of the driving device operated by combustion pressure is characterized in that the switching device has a connection for the expansion space. As a result, a fluidic connection between the output side of the fluid conveying device and the expansion space is made possible in a simple manner.

A further preferred exemplary embodiment of the driving device operated by combustion pressure is characterized in that the switching device has at least one connection for a region of the driving device to be cooled. As a result, a fluidic connection between the output side of the fluid conveying device and the area of the driving device to be cooled is made possible in a simple manner.

A further preferred embodiment of the driving device operated by combustion pressure is characterized in that the switching device is connected to a controller in a manner allowing control. The controller is, for example, a control device integrated into the driving device. The controller is advantageously connected to at least one sensor device. By way of example, a pressure in the combustion chamber is detected by means of the sensor device. Alternatively or additionally, a pressure in the expansion space can be detected by means of the sensor device. Alternatively or additionally, a position of the driving piston in the driving device can be detected by means of the sensor device.

A further preferred exemplary embodiment of the driving device operated by combustion pressure is characterized in that the fluid conveying device is a pump or a compressor with only one conveying direction or flow direction. By way of example, the fluid conveying device is driven in a simple manner by an electric motor which is integrated into the driving device. The electric motor can advantageously be an electric motor already present in the driving device. By using a fluid conveying device with only one conveying direction or flow direction, it is possible to use pumps of a type of pump with a relatively simple construction, such as centrifugal pumps.

In a method for operating a combustion-operated driving device described above, the above-mentioned problem is alternatively or additionally addressed in that, with one and the same fluid conveying device, different locations in or on the driving device are supplied with the volume flow, or with a partial volume flow, at different times during the operation of the driving device. It is also advantageously possible to provide, with one and the same fluid conveying device, and in particular at the same time, different partial volume flows to different locations in or on the driving device. This accordingly enables, in a simple manner, particularly varied applications for the fluid conveying device in the driving device.

A preferred embodiment of the method is characterized in that at least one, several, or all of the following method steps are carried out: the combustion chamber is connected via the switching device to the output side of the fluid conveying device to charge the combustion chamber with a pressure which is higher than that of an environment of the driving device; and as a result, the driving function of the driving device can be improved.

According to a further method step, the expansion space is connected via the switching device to the output side of the fluid conveying device in order to reset the driving piston after a driving operation; and the driving piston is preferably returned and/or moved back to a starting position during the resetting. After the resetting of the driving piston into its starting position, a new driving operation can be initiated.

According to a further method step, a region of the driving device to be cooled, in particular a cylinder of the driving device, is connected via the switching device to the output side of the fluid conveying device in order to cool the region to be cooled. In the region to be cooled, cooling fins are advantageously included on the outside of the cylinder. The volume flow, in particular an air flow, is then supplied to the cooling fins in order to cool the cylinder, in particular the combustion chamber in the interior of the cylinder.

By means of the switching device, and in particular at the same time, partial flows can be conveyed in a simple manner from the output side of the fluid conveying device in different lines to a plurality of locations in or on the driving device. The switching device enables easy switching between different constellations. By way of example, the combustion chamber can be pressurized, and, at the same time, the cylinder can be cooled by an air flow. According to a further embodiment, the piston can be reset by supplying air to the expansion space, while the cylinder of the driving device is cooled at the same time with an air flow to the area to be cooled, which is equipped with cooling fins.

The invention further relates to a fluid conveying device and/or a switching device for a driving device described above. The named devices can be addressed separately.

Further advantages, features and details of the invention will become apparent from the following description in which, with reference to the drawings, various embodiments are described in detail.

### EMBODIMENTS OF THE INVENTION

The single accompanying FIGURE illustrates a driving device operated by combustion pressure, having a fluid conveying device and a switching device, in a simplified, longitudinal section.

The FIGURE illustrates a driving device 1 in a greatly simplified manner, in longitudinal section. The driving device 1 illustrated in the FIGURE can be operated with a combustion gas, or with a vaporizable liquid fuel.

The driving device 1 comprises a housing 3 with a cylinder 5 in which a combustion chamber 6 is arranged. An ignition device 7 by means of which combustion gas, in particular a combustion gas/air mixture, can be ignited in the combustion chamber 6 is indicated in the combustion chamber 6.

The housing 3 of the driving device 1 further comprises a piston guide 8 for a driving piston 10. The driving piston 10 comprises a piston rod 11, which extends from a piston head 12. The end of the piston rod 11 remote from the piston head 12 is arranged in a bolt guide 14 which serves to guide fastening elements, which are also referred to as bolts.

The bolt guide 14, with the piston rod 11 of the driving piston 10 arranged therein, is also referred to as a driving mechanism. A fastening element, such as a nail, bolt, or the like, can be driven into a workpiece (not shown) via the driving mechanism. The workpiece can be a wall in a building.

Before driving a fastening element, the driving device 1 is pressed with the bolt guide 14 against the workpiece, and triggered. A switch (not shown), which is also referred to as a trigger switch, serves to trigger a driving process. The switch is included, for example, on a grip (also not shown) of the driving device.

The combustion chamber 6 and the driving piston 10 with the piston head 12 are also part of the driving mechanism. The piston head 12 comprises a first piston surface 21 which faces the combustion chamber 6. A second piston surface 22 which faces away from the combustion chamber 6 defines an expansion space 25 in the housing 3 of the driving device 1. The piston rod 11 of the driving piston 10 extends from the piston head 12 through the expansion space 25 into the bolt guide 14.

The driving device 1 further comprises a fluid conveying device 30 having an input side 31 and an output side 32. A switching device 40 is arranged on the output side 32 of the fluid conveying device 30. The switching device 40 is fluidly connected by fluid lines (not illustrated in detail) to the fluid conveying device 30, and to different locations in and/or on the driving device 1.

The housing 3 of the driving device 1 is preferably used only, and/or mainly, for accommodating the drive mechanism of the driving device 1. The driving device 1 includes, for example, a further housing (not shown), which is also referred to as an outer housing. Analogously, the housing 3 in the driving device 1 can also be referred to as an inner housing. The inner housing 3 is advantageously connected to the outer housing.

The fluid conveying device 30 is, for example, a pump with only one conveying direction. The pump is designed, for example, as a centrifugal pump. The conveying medium for the fluid conveying device 30 is preferably air. Therefore, the fluid conveying device 30 can also be referred to as a compressor.

An arrow 41 indicates that the fluid conveying device 30 is supplied with a fluid, in particular air, via the input side 31. A further arrow 42 indicates that the fluid is guided and/or conducted from the output side 32 of the fluid conveying device 30 to the switching device 40. Arrows 43, 44, 45 indicate that the fluid conveying device 30 can guide and/or convey different volume flows or partial volume flows to different places in and/or on the driving device 1 via the switching device 40.

The arrow 43 indicates that a volume flow and/or a partial volume flow is conveyed into the combustion chamber 6 by the fluid conveying device 30 via the switching device 40. The arrow 44 indicates how a volume flow and/or a partial volume flow is guided and/or conveyed into the expansion space 25 by the fluid conveying device 30 via the switching device 40.

The arrow 45 indicates how a volume flow and/or a partial volume flow is guided and/or conveyed to a region to be cooled 50 by the fluid conveying device 30 via the switching device 40. The region to be cooled 50 is on the outside of the cylinder 5 of the inner housing 3 of the driving device 1. To improve the cooling effect, a total of four cooling fins 54 are included on the outside of the cylinder 5.

1. A driving device operated by combustion pressure, for driving fastening elements, the driving device comprising at least one combustion chamber; a driving piston which has a first piston surface which faces the combustion chamber, and a second piston surface which faces away from the combustion chamber and defines an expansion space; a fluid conveying device which conveys a volume flow, the fluid conveying device having an output side; and a switching device arranged on the output side of the fluid conveying device by which the volume flow can be entirely or partially conveyed by the fluid conveying device to different locations in or on the driving device.

2. The driving device according to claim 1, wherein the switching device is a valve device with at least three connections, one of which is connected to the output side of the fluid conveying device.

3. The driving device according to claim 1, wherein the switching device has a connection for the combustion chamber.

4. The driving device according to claim 1, wherein the switching device has a connection for the expansion space.

5. The driving device according to claim 1, wherein the switching device has at least one connection for a region of the driving device to be cooled.

6. The driving device according to claim 1, wherein the switching device is connected to a controller in a manner allowing control.

7. The driving device according to claim 1, wherein the fluid conveying device is a pump or a compressor with only one conveying direction or flow direction.

8. A method for the operation of a driving device operated by combustion pressure, for driving fastening elements, the driving device comprising at least one combustion chamber; a driving piston which has a first piston surface which faces the combustion chamber, and a second piston surface which faces away from the combustion chamber and defines an expansion space; a fluid conveying device which conveys a volume flow, the fluid conveying device having an output side; and a switching device arranged on the output side of the fluid conveying device by which the volume flow can be entirely or partially conveyed by the fluid conveying device to different locations in or on the driving device,
the method comprising supplying different locations in or on the driving device with volume flow or with a partial volume flow with the same fluid conveying device, at different times during operation of the driving device.

9. The method according to claim 8, including at least one, several or all of:
connecting the combustion chamber via the switching device to the output side to charge the combustion chamber with a pressure which is higher than that of an environment of the driving device;
connecting the expansion space via the switching device to the output side of the fluid conveying device to reset the driving piston after a driving operation;
connecting a region to be cooled of the driving device via the switching device to the output side of the fluid conveying device (30) to cool the region to be cooled.

10. A fluid conveying device and/or switching device for a driving device operated by combustion pressure, for driving fastening elements, the driving device comprising at least one combustion chamber; a driving piston which has a first piston surface which faces the combustion chamber, and a second piston surface which faces away from the combustion chamber and defines an expansion space; a fluid conveying device which conveys a volume flow, the fluid conveying device having an output side; and a switching device arranged on the output side of the fluid conveying device by which the volume flow can be entirely or partially conveyed by the fluid conveying device to different locations in or on the driving device.

11. The method of claim 9, wherein connecting the region to be cooled of the driving device includes connecting a cylinder of the driving device via the switching device to the output side of the fluid conveying device.

12. The driving device according to claim 2, wherein the switching device has a connection for the combustion chamber.

13. The driving device according to claim 2, wherein the switching device has a connection for the expansion space.

14. The driving device according to claim 2, wherein the switching device has at least one connection for a region of the driving device to be cooled.

15. The driving device according to claim 3, wherein the switching device has at least one connection for a region of the driving device to be cooled.

16. The driving device according to claim 4, wherein the switching device has at least one connection for a region of the driving device to be cooled.

17. The driving device according to claim 2, wherein the switching device is connected to a controller in a manner allowing control.

18. The driving device according to claim 3, wherein the switching device is connected to a controller in a manner allowing control.

19. The driving device according to claim 4, wherein the switching device is connected to a controller in a manner allowing control.

20. The driving device according to claim 5, wherein the switching device is connected to a controller in a manner allowing control.
